(19) United States
(12) Patent Application Publication
(10) Pub. No.: US 2008/0302859 A1
(43) Pub. Date: Dec. 11, 2008

(54) METHOD OF REFLOW SOLDERING A PRINTED CIRCUIT BOARD WHEREIN AN ELECTROCONDUCTIVE COATING MATERIAL IS USED

(75) Inventors: Nobuo Kasagi, Toyama (JP); Kenichi Hashimoto, Toyama (JP)

Correspondence Address: DARBY & DARBY P.C., P.O. BOX 770, Church Street Station, New York, NY, 10008-0770, US

(73) Assignee: SMK Corporation, Tokyo (JP)

(21) Appl. No.: 12/133,521

(22) Filed: Jun. 5, 2008

(30) Foreign Application Priority Data
Jun. 8, 2007 (JP) 2007-152509

(51) Int. Cl. B23K 1/20

(52) U.S. Cl. 228/176

(57) ABSTRACT

A reflow soldering method for use with circuit patterns and land patterns formed by an electoconductive coating material. Reflow soldering is performed in an air atmosphere within a range of 150°-190° C. and with a preheating time set within a range of 60±30 sec. Alternatively, preheating is performed in a nitrogen atmosphere.

### CROSS-REFERENCE TO RELATED APPLICATION

The present application claims priority from Japanese Patent Application No. 2007-152509, filed on Jun. 8, 2007, and is hereby incorporated by reference in its entirety herein.

### FIELD OF THE INVENTION

The present invention relates to a surface mount soldering method that mounts an electronic component on a printed circuit board, wherein an electroconductive coating material is used.

### BACKGROUND OF THE INVENTION

The fabrication of a printed circuit board, wherein a circuit pattern is formed by etching a copper clad board, incurs a high environmental burden in the chemical etching process and requires special processing equipment, and therefore the use of an electroconductive coating material to form a circuit pattern is being studied.

However, electroconductive coating materials have poor solder wettability and are difficult to use in the field of surface mount soldering.

Japanese Unexamined Patent Application Publication No. 2006-28213 discloses an electroconductive coating material using a mixture of Ag-coated Ni powder and Ag powder as a filler, using a setting resin such as phenol resin as a binder, and using an organic solvent, such as butyl carbitol, to adjust the viscosity so that the coating material can be screen printed.

In addition, it is said that an oxide film that naturally forms on the surfaces of the particles of the metal powder can be eliminated by mixing in a polyunsaturated fatty acid, such as oleic acid.

The applicant of the present application evaluated a reflow soldering method wherein the abovementioned electroconductive coating material, in which the polyunsaturated fatty acid is mixed, is used.

Reflow soldering is a surface mounting method wherein a land pattern is printed with a cream solder, an electronic component is mounted to that land, and then the solder is heated so that it reflows.

In this case, in order to activate the flux contained in the cream solder, a process is generally used wherein the board is preheated in the atmosphere at 150°-190° C. for approximately 95-120 min, and then heated to the reflow soldering temperature of 230°-240° C.

Unfortunately, when a test was conducted in a conventional reflow oven using such a conventional reflow soldering to screen print a land pattern of a circuit pattern with the abovementioned electroconductive coating material mixed with the polyunsaturated fatty acid, it was found that the solder wettability of the land part was inadequate.

As an alternate approach, Japanese Unexamined Patent Application Publication No. H6-3744 discloses a technology wherein the temperature is raised continuously and gradually from the preheating temperature to the reflow temperature in order to prevent reoxidation of, for example, joints between parts after preheating is preformed in the reflow soldering method.

However, although the technical idea of the invention in the abovementioned publication prevents reoxidation of joints after preheating, there is a problem in that the preheating time is short, which produces inconsistent flux activation, and therefore the invention cannot be adapted to a land pattern wherein an electroconductive coating material is used.

### SUMMARY OF THE INVENTION

An object of the present invention is to provide a reflow soldering method that effectively improves solder wettability in cases wherein an electroconductive coating material is used in circuit patterns and land patterns.

In a reflow soldering method, according to the present invention a circuit pattern is screen printed on an insulator board with an electroconductive coating material, a land part of the circuit pattern is printed with cream solder, a component is mounted on the land part, and then the cream solder is reflowed; wherein, the temperature of preheating, which activates the flux, is set within a range of 150°-190° C. and the preheating time is set within a range of 60±30 seconds.

In the present invention, the preheating time was set within the range of 30-90 seconds because it was discovered that the surfaces of the particles of the metal powder in the electroconductive coating material are not activated unless heating is maintained for 30 seconds or longer; furthermore, if the preheating time exceeds 90 seconds, then, surprisingly, solder wettability degrades once again.

It is assumed that this occurs because, in contrast to a conventional copper clad land pattern wherein the preheating time is generally around 100 seconds, the surfaces of the particles of the metal powder in the electroconductive coating material oxidize because of the oxygen in the air.

When more detailed experiments were performed, it was found that the metal powder did not activate with a preheating time of 25 seconds, and that the land part oxidized when the preheating time was 95 sec, thereby degrading solder wettability.

Accordingly, a preheating time of 60±30 sec is preferable, and a range of 55-75 seconds is more preferable.

In addition, it was discovered that the solder wettability of the land was satisfactory when the preheating temperature was set to 115°-190° C. and the preheating time was set to approximately 95 seconds in a nitrogen atmosphere in order to prevent oxidation of the land part.

Furthermore, the oxidation concentration in a reflow oven at this time was 3,500 ppm.

Accordingly, it was discovered that preheating may be performed in the reflow oven in a nitrogen atmosphere with an oxygen concentration of less than 4,000 ppm.

Furthermore, it was discovered that the preheating time was affected by the oxygen concentration in the nitrogen atmosphere, and a preheating time of 30-120 seconds was preferable when the oxygen concentration was in the range of 3,000-4,000 ppm.

In summary, the present invention is directed to a case wherein a land pattern was printed with an electroconductive coating material, after which a cream solder was printed and then preheating was performed in a reflow oven at 150°-190° C. for 60±30 sec either in the atmosphere or in a nitrogen atmosphere, which resulted in improved solder wettability of the land pattern and superior solder bonding strength.

### BRIEF DESCRIPTION OF THE DRAWINGS

The invention will become more readily apparent from the Detailed Description of the Invention, which proceeds with reference to the drawings, in which:

FIGS. 1(a)-1(c) show the results of the evaluation of solder wettability in a reflow oven;

FIGS. 2(a)-2(b) show a remote control board whereon a component is mounted; and

FIG. 3 illustrates an EPMA of a cross section of a solder portion.

### DETAILED DESCRIPTION OF THE PREFERRED EMBODIMENTS

The reflow soldering method according to the present invention can be adapted to various electronic boards wherein an electroconductive coating material is used to form a land pattern. As explained below, the present working example evaluated an exemplary case involving a remote control board for remotely controlling an electronic device.

In order to prepare a paper phenol board material, a paper base material was impregnated with a phenol resin by coating a board material (for example, PS-1131 made by Risho Kogyo Co., Ltd. of Tokyo, Japan), which has a thickness of 1.6 mm and an absorption percentage of 2.0 percent, with a resist layer (for example, FINEDEL DSR-330R14-13 resist made by Tamura Corporation of Tokyo, Japan). Subsequently, a circuit pattern was screen printed on the board with the electroconductive coating material.

The electroconductive coating material that was used in the evaluation is made by Maxell Hokuriku Seiki, Ltd. of Toyama, Japan, and is manufactured by mixing Ag-coated Ni powder and Ag powder, using phenol resin as a binder, and then mixing in oleic acid and an organic solvent, i.e., butyl carbitol. This coating material is further described in Japanese Unexamined Patent Application Publication No. 2006-28213.

After the circuit pattern including a wiring pattern and a land pattern were screen printed with the electroconductive coating material, a drying oven was used to dry the board material for approximately 30 minutes at 160° C.

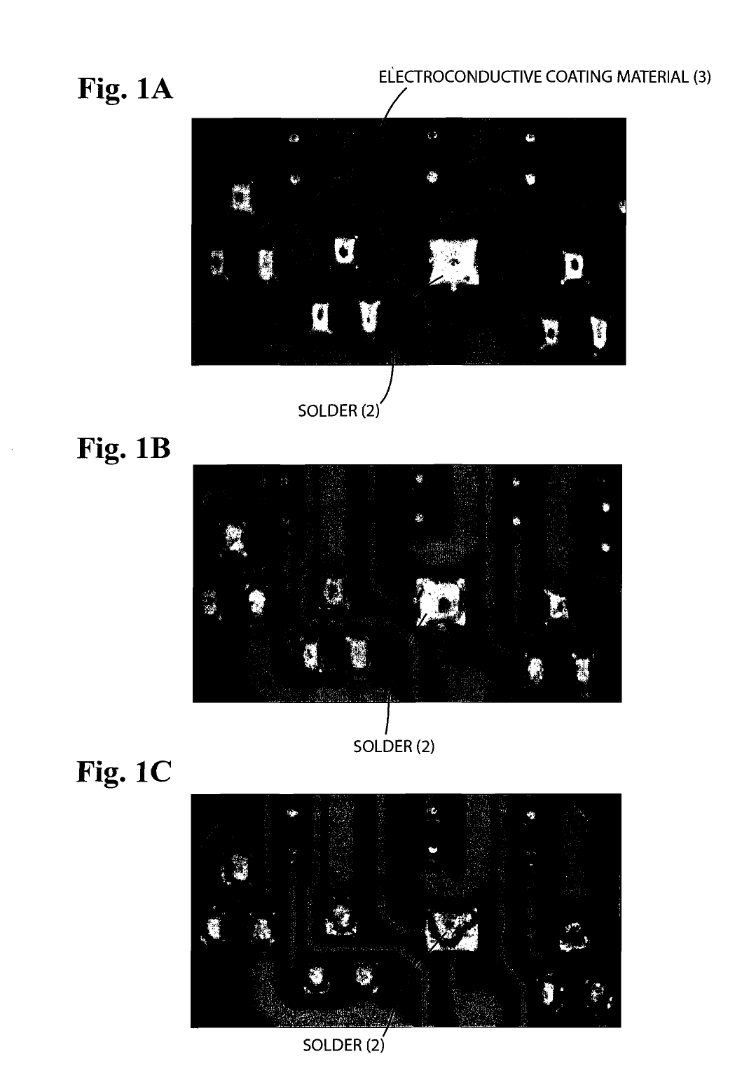

FIG. 1 shows the results of a test wherein a lead-free cream solder (M705 made by Senju Metal Industry Co., Ltd. of Tokyo, Japan) was printed on the land pattern and then reflowed in a reflow oven (1812 EXL-N2/UL made by Heller Industries, Inc. of Florham Park, N.J.).

FIG. 1(a) shows the case wherein the board was preheated to 150°-190° C. for 95 seconds in a nitrogen atmosphere that reached an oxygen concentration level of 3,500 ppm, after which the solder 2 was reflowed at 230°-240° C. onto the electroconductive coating material 3. In this case, the solder wettability of the land was satisfactory.

FIG. 1(b) shows the case wherein the board was preheated to 150°-190° C. for 55-60 seconds in the atmosphere, after which the solder 2 was reflowed at 230°-240° C. In this case as well, solder wettability was satisfactory, the same as in FIG. 1(a).

FIG. 1(c) shows the case wherein the board was preheated to 150°-190° C. for 95 seconds in the atmosphere, after which the solder 2 was reflowed at 230°-240° C.; however, in this case, solder wettability of the land was inadequate.

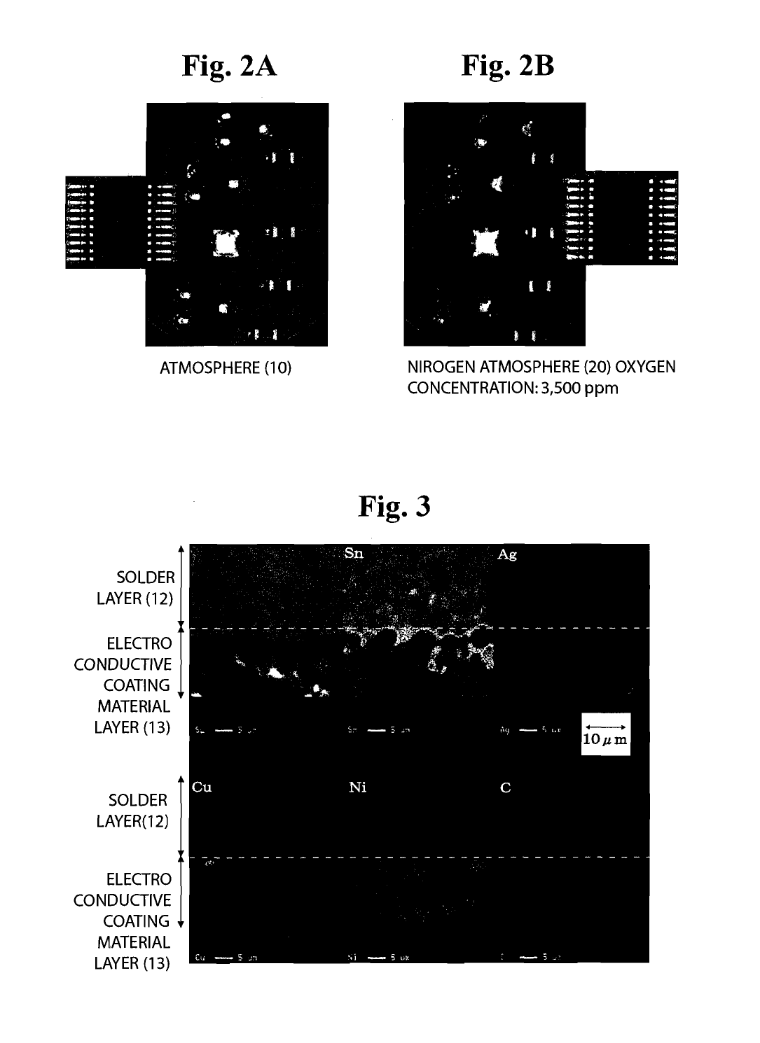

FIG. 2 shows the results of a test which a component was actually mounted to the remote control board, after which an evaluation was conducted.

In the case in which preheating was performed in an air atmosphere 10, it was possible to mount the component satisfactorily, as shown in FIG. 2(a), by setting the heating time to 30-90 seconds.

In addition, when preheating was performed in the nitrogen atmosphere 20, even more satisfactory solderability was exhibited, as shown in FIG. 2(b).

In addition, the chip component shown in FIG. 2(a) was pressed from its side parts and the solder joint strength was evaluated; the results indicated that the surface that peeled with a peeling strength of 8.5-25.5 N was the bonding surface between the paper phenol and the electroconductive coating material.

There were no problems with quality provided that the soldering strength of the chip component was 10 N/mm² or greater; furthermore, although the standard for the case of the land surface area shown in FIG. 2(a) is 6.4 N or greater, the present test results were 8.5-25.5 N, and therefore it was clear that the soldering strength was adequate.

FIG. 3 shows the results of an Electron Probe Micro-Analysis (EPMA) of a cross section of the test sample shown in FIG. 1(b).

It was clear that Sn, Ag, Cu, and the like from the solder layer 12 were diffused in the electroconductive coating material layer 13.

Sn, Ag, and Cu were diffused in the electroconductive coating material because the solder used in the present test and evaluation was a three-element, lead-free solder of the Sn—Ag—Cu type.

Furthermore, the solder of the present invention is not particularly limited thereto as long as it is a reflow solder; furthermore, the Sn—Pb type solder widely employed in the past may be used.

1. A method of reflow soldering a printed circuit board, wherein an electroconductive coating material is used, comprising the steps of:
screen printing a circuit pattern on an insulator board with an electroconductive coating material;
printing a land part of the circuit pattern with cream solder;
mounting a component on the land part; and
reflowing the cream solder;
wherein,
the temperature of preheating, which activates the flux, is set within a range of 150°-190° C. and the preheating time is set within a range of 60±30 sec.

2. A method of reflow soldering a printed circuit board, wherein an electroconductive coating material is used, comprising the steps of:
screen printing a circuit pattern on an insulator board with an electroconductive coating material;
printing a land part of the circuit pattern with cream solder;
mounting a component on the land part; and
reflowing the cream solder;
wherein,
preheating, which activates a flux, is performed in a nitrogen atmosphere.

3. The method of claim 2, wherein the nitrogen atmosphere has an oxygen concentration that is less than 4,000 ppm.
